(19) United States
(12) Patent Application Publication
(10) Pub. No.: US 2022/0255928 A1
(43) Pub. Date: Aug. 11, 2022

(54) SYSTEMS AND METHODS FOR DEVICE LOCATION VERIFICATION

(71) Applicant: DISH Wireless L.L.C., Englewood, CO (US)

(72) Inventors: Evan Tedesco, Highlands Ranch, CO (US); Christopher Ergen, Littleton, CO (US)

(21) Appl. No.: 17/168,577

(22) Filed: Feb. 5, 2021

(51) Int. Cl. H04L 29/06; H04L 9/32; G06F 16/245; G06F 16/29; G06Q 20/06; H04W 4/029

(52) U.S. Cl. CPC H04L 63/0876; H04L 9/3218; H04L 9/321; G06F 16/245; G06F 16/29; G06Q 2220/00; H04W 4/029; H04L 2209/38; H04L 2463/121; H04L 2209/56; G06Q 20/0658

(57) ABSTRACT

Examples of the present disclosure describe systems and methods for verifying the location of a device using blockchain technology and zero-knowledge proofs (ZKPs). In one example aspect, a system may receive raw geolocation and timestamp data from a device. The geolocation data may be corroborated by other third-party trusted devices in a network. Upon receiving the raw geolocation and timestamp data, the system may construct at least one ZKP. In one example, the ZKP involves determining whether the geolocation of the device is within an authorized region from a database of authorized regions. If the geolocation is determined to be in an authorized region, then a ZKP predicate stating that the device was in an authorized region may be constructed. This ZKP predicate may be written to a blockchain so that a verifier may read the block and verify the device's location without receiving the raw, underlying geolocation/timestamp data.

### TECHNICAL FIELD

The present disclosure relates to the fields of location-based services, blockchain systems, and zero-knowledge proofs.

### BACKGROUND

Receiving and validating a location of a device is a common and important process in today's Internet-of-Things (IoT) environment. For example, identifying the location of a device is useful for validating a user login attempt or for determining which local network towers and/or satellites should be activated to communicate with the device most efficiently. As such, validating and verifying a device location, as well as a timestamp, continues to be increasingly important in today's IoT-connected world, especially in light of the rise of fraudulent login attempts, hacking, spoofing, and other nefarious activity related to IoT devices. There is therefore a need to more securely validate location and timestamp data from IoT devices.

Most location data is in the form of Keyhole Markup Language (KML), which is an XML notation for expression geographic annotation and visualization within two-dimensional maps and three-dimensional browsers (e.g., Google Earth). Additionally, a frequent indication of time for a device can be in the form of a Unix timestamp, which is a system for describing a point in time. Unix time is widely used in operating systems and file formats. It serves as a way to track time as a running total of seconds. A Unix timestamp is also interpreted the same regardless of region and is calculated from the same point in time regardless of time zone.

One facet of the present application is blockchain-based technology. A blockchain is a continuously growing list of records, called blocks, which are linked and secured using cryptography. Each block may contain a hash pointer as a link to a previous block, a timestamp, and transactional data (e.g., each block may include many transactions). By design, a blockchain is inherently resistant to modification of the transactional data. A blockchain may be managed by a peer-to-peer network of nodes (e.g., devices) collectively adhering to a consensus protocol for validating new blocks. Once recorded, the transaction data in a given block cannot be altered retroactively without the alteration of all previous blocks, which requires collusion of a majority of the network nodes.

A blockchain is an append-only data structure maintained by a network of nodes that do not fully trust each other. A permissioned blockchain is a type of blockchain where access to the network of nodes is controlled in some manner, e.g., by a central authority and/or other nodes of the network. All nodes in a blockchain network agree on an ordered set of blocks, and each block may contain one or more transactions, or other data/metadata. Thus, a blockchain may be viewed as a log of ordered transactions. One particular type of blockchain (e.g., Bitcoin) stores coins as system states shared by all nodes of the network. Bitcoin-based nodes implement a simple replicated state machine model that moves coins from one node address to another node address, where each node may include many addresses. Furthermore, public blockchains may include full nodes, where a full node may include an entire transactional history (e.g., a log of transactions), and a node may not include the entire transactional history. For example, Bitcoin includes thousands of full nodes in all of the nodes that are connected to Bitcoin.

Another facet of the present application involves Zero-Knowledge Proof (ZKP), which is tangentially related to blockchain technology. ZKP is a method by which one party (the prover) can prove to another party (the verifier) that they know a value x, without conveying any information apart from the fact that they know the value x. The essence of zero-knowledge proofs is that it is trivial to prove that one possesses knowledge of certain information by simply revealing it; the challenge is to prove such possession without revealing the information itself or any additional information. By design, ZKP is beneficial for a user's privacy, as a user (as the prover) is able to reveal that they have certain knowledge, but they are able to refrain from revealing the actual underlying knowledge to the verifier.

A protocol implementing zero-knowledge proofs (ZKPs) of knowledge can either require interactive or non-interactive inputs. Either interactive or non-interactive ZKPs may be used with the embodiments described herein. With regard to the interactive input embodiment, an interactive input may be received from a verifier. This interactive input is usually in the form of one or more challenges that the responses from the prover will convince the verifier if and only if the statement is true, i.e., if the prover does possess the claimed knowledge. The ultimate response the verifier may receive from the prover may be in the form of a predicate, which is simply a Boolean statement (e.g., Yes/No, True/False, etc.).

Presently, most systems do not validate or verify device geolocation data. These systems accept device responses without any further corroboration, and any subsequent requests to verify device geolocation data is simply involve revealing the device geolocation data presented to the system previously. This design leaves IoT devices and systems open for fraudulent activity and inability to verify device location data with a high degree of confidence. Certain user data may be exposed and leaked. As such, there is a need to securely verify device geolocation data, while maintaining user privacy.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following figures.

FIG. 1 illustrates an example of a distributed system for verifying a device geolocation.

FIG. 2 illustrates an example distributed blockchain architecture for verifying a device geolocation.

FIG. 3 illustrates an example input processing system for implementing systems and methods for verifying a device geolocation.

FIG. 4 illustrates an example method for storing a verified device location on a blockchain.

FIG. 5 illustrates an example method for verifying a device location using a zero-knowledge proof.

FIG. 6 illustrates an example data exchange using a prover, blockchain, and a verifier.

FIGS. 7A and 7B illustrate example graphical user interfaces of verifying a geolocation and timestamp of an image displayed on a mobile device.

FIG. 8 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Embodiments of the present application are directed at systems and methods for verifying a device geolocation and timestamp data. Throughout this application, reference may be made to “geolocation data” alone and/or geolocation and timestamp data together. “Geolocation data” is to be interpreted as both location data and an associated timestamp for when a device was at a certain location. Specifically, the present application is directed to verifying device geolocation and timestamp data using blockchain technology and zero-knowledge proofs. In one example aspect, a device geolocation and timestamp data is received by a system. The system may generate a digital record of the data received by the device and proceed to check the veracity of the data by interfacing with third-party trusted sources. For example, the system may receive logs from nodes in a network system that contain information whether a certain device had communicated with certain nodes. A WiFi router in a certain geographic area may have communicated with the device at a particular time, which corroborates the geolocation data and timestamp data the device originally transmitted to the system.

In another example, the device location may have been recorded when the device was used to engage in a transaction. For example, if the device was used to collect cryptocurrency at a particular location, such device location data would be recorded and available for the system to receive and cross-check the location and timestamp data the device originally provided to the system. In other examples, a transaction at a supermarket may have been recorded by the device. The location of the supermarket may be logged by the system and compared to the geolocation and timestamp data supplied by the device.

As more and more nodes in a network corroborate the location of a device, a certain confidence threshold may be reached by the system. Once the confidence threshold is reached, the verification of the device location and timestamp may be added to a blockchain. In some instances, the actual device location and timestamp data may be added to the blockchain. In other instances, a verification statement that a device was in a location at a certain time may be stored on the blockchain, hiding the actual location and timestamp location from other nodes in the blockchain network.

Once a device geolocation and timestamp data has been recorded to the blockchain, a verifier may request verification information about the device's geolocation and timestamp data. In some instances, the verifier may be able to query the blockchain, and the blockchain may be able to supply the verifier with a verified statement that the device was at a particular geolocation at a particular time. Additionally, the record in the blockchain (i.e., block) may also contain the corroborating evidence from other network nodes showing that a particular device was in the geographic area at a certain time.

In other instances, the owner of the device may want to prove to a verifier that the device was indeed in a certain location at a certain time but without revealing that particular location and time to the verifier. For example, a verifier may want to ensure a device was operating in an authorized region. Rather than supplying the verifier with the exact geocoordinates and timestamp data of the device, the prover may be able to simply prove to the verifier that the device was operating in an authorized region without supplying the exact details of the location/timestamp. Such proof may be implemented through a zero-knowledge proof on a blockchain.

Specifically, the prover may be an intermediary secured server and/or node in a network that receives device geolocation and timestamp data from a trusted third party. This information may be in the form of KML data and Unix timestamp data. This data may be cross-checked with a database of “authorized locations,” and if the geolocation and timestamp data fall into one of the authorized locations, the prover may provide a ZKP predicate to a publicly-accessible blockchain and store the ZKP predicate on the blockchain. The predicate may simply be a statement verifying the device was operating in an authorized location at a particular time without any details of the exact geocoordinates and timestamp. A verifier may query the blockchain, and the blockchain may provide the predicate response (i.e., the device was operating in an authorized region at a particular time) and the proof. The proof of the ZKP predicate may be, for example, the algorithm that produced the predicate but without the initial trusted third-party response, which would include the exact geolocation and timestamp of the device. In other words, by implementing a ZKP on a blockchain, verifiers are able to obtain device location verification data without actually knowing the precise geocoordinates and timestamp data of that device, thereby protecting the privacy of the users of the devices at issue.

In some examples, the geolocation data may be associated with a WiFi node (e.g., router, hot spot, etc.), a terrestrial radio, a satellite, another device, and/or a combination of the aforementioned. When a device communicates with a node in a network, a location “ping” may be recorded, which comprises both location and timestamp data of the device. This data may be used to verify whether a device is in a certain authorized location or not, for example. When a verifier requests this data, however, application of a ZKP may shield the raw geolocation and timestamp data from the verifier and instead provide the verifier with a verified ZKP predicate and a proof. This protects the privacy of the user of the device, while also providing the requisite information to the verifier.

The techniques disclosed herein increase the security and operability of devices in a network by providing systems and methods that obscure the underlying device geolocation and timestamp data from verifiers requesting said data. This decreases the number of times the raw, underlying geolocation and timestamp data is distributed across a network, thereby decreasing the probability of a device being compromised.

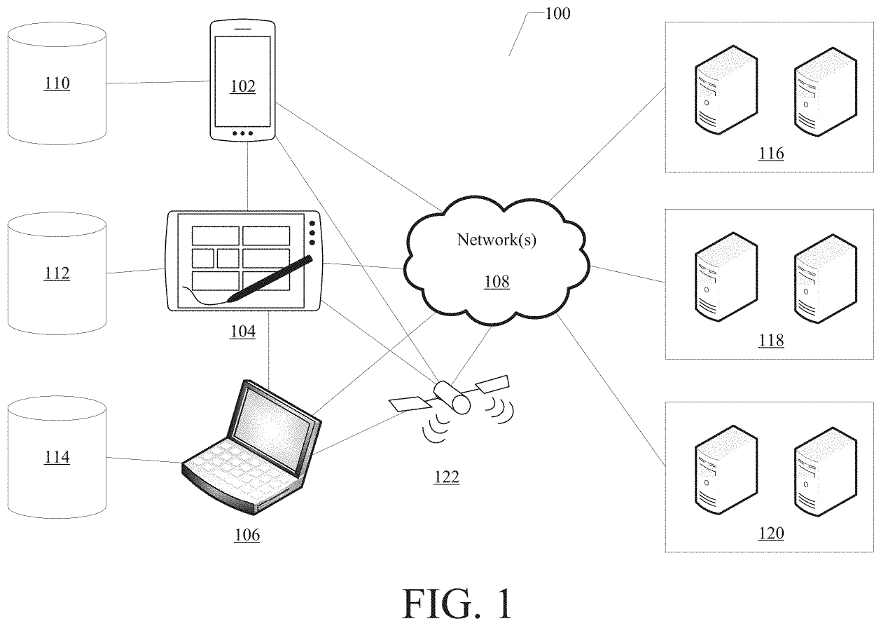

FIG. 1 illustrates an example of a distributed system for verifying a device geolocation. Example system 100 presented is a combination of interdependent components that interact to form an integrated whole verifying a device geolocation. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and/or 106 may be configured to receive geolocation transmissions from other devices in a network, such as network(s) 108. Such geolocation transmissions/signals may be in the form of a “ping,” which may include KML location data and/or Unix timestamp data. Similarly, client devices 102, 104, and/or 106 may be configured to transmit geolocation transmissions across a network, such as network(s) 108. Such geolocation data may comprise KML location data and Unix timestamps. In one example, a client device 102 may be a mobile phone, client device 104 may be a tablet, and client device 106 may be a laptop/personal computer. Other possible client devices include but are not limited to set-top boxes, Over-the-Air antennas, televisions (e.g., smart televisions), etc.

In some example aspects, client devices 102, 104, and/or 106 may be configured to communicate with a GPS satellite, such as satellite 122. GPS satellite 122 may be a satellite (or multiple satellites) within the GPS constellation. Client devices 102, 104, and/or 106 may receive GPS location data from satellite 122, confirming the GPS location of the device. The GPS location data received by client devices 102, 104, and/or 106 may be stored local databases 110, 112, and/or 114. Additionally, such GPS location data may be stored remotely at remote servers 116, 118, and/or 120. In other examples, client devices 102, 104, and/or 106 may be configured to communicate with one another via near-range communication protocols, such as Bluetooth. Such communications may be in the form of a “ping,” which may capture a device's geolocation position and timestamp.

Client devices 102, 104, and/or 106 may also be configured to run software that implements a blockchain for storing device geolocation data and/or device geolocation verification data. Furthermore, client devices 102, 104, and/or 106 may be configured to run software that constructs a ZKP for verifying device geolocation data and transmits a ZKP predicate to store on a blockchain.

For example, client device 104 may receive GPS location data from satellite 122. Client device 104 may also ping client devices 102 and 106, whereby additional geolocation data and timestamps associated with device 104 are stored on client devices 102 and 106 (e.g., in communication logs). To verify client device 104′s location, the system may solicit corroborating evidence from other nodes in the network. For instance, geolocation data from satellite 122, client device 102, and client device 106 may be transmitted to the system to verify the location of client device 104. In other instances, the system may accept client device's 104 transmission of its geolocation data as true without further corroboration. This geolocation data from client device 104 may be stored locally at local database 112, as well as on a blockchain stored on nodes 116, 118, and/or 120.

A verifier may request to verify the location of client device 104. Specifically, a verifier may request that client device 104 verify that it was operating in an authorized geolocation at a specific time. The verifier may be able to query the blockchain, which is stored as copies on various nodes throughout the blockchain network (e.g., on nodes 116, 118, 120, as well as nodes 102, 104, and 106). The blockchain may comprise a block of the raw, underlying data of client device 104, in some instances. In other instances, the system receiving client device 104′s geolocation data may compare that geolocation data to a database of authorized regions, and if the geolocation data from client device 104 is within one of the authorized regions, the system may generate a predicate response, such as a statement to the effect of “TRUE: IN AUTHORIZED REGION.” Such a predicate may then be transmitted to a blockchain hosted by one of the nodes in the blockchain network. When a verifier queries the blockchain to verify the location of client device 104, the verifier may receive the predicate response and the underlying proof (e.g., zero-knowledge proof) that resulted in the predicate response. None of the actual underlying geolocation and timestamp data associated with client device 104 is available, however, to the verifier in this instance.

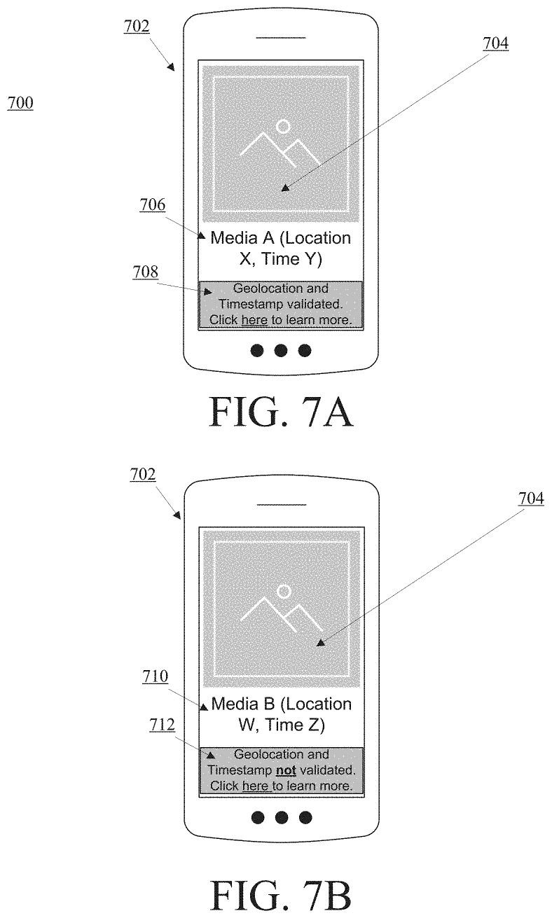

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to query a blockchain to receive location verification information associated with laptop device 106. A graphical user interface may display on the mobile device 102 indicating the location verification information associated with that device. In other examples, a graphical user interface may display certain multimedia items, such as pictures and videos, that were captured from a client device (e.g., client device 106). If the location and timestamp data of the client device when it captured the multimedia content is verified, then the multimedia items may include an indicator stating that the geolocation and timestamp information for this multimedia item has been verified. Further examples of this embodiment are illustrated with respect to FIGS. 7A and 7B. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106.

In other example aspects, devices 116, 118, and/or 120 may be databases that are utilized in constructing ZKPs. For instance, one database may comprise authorized regions (e.g., GPS coordinates identifying a perimeter of a particular geolocation). In another example, a database may comprise certain “ping” logs from certain nodes in a network that identify certain devices, geolocations, and timestamps. In yet another example, a database may comprise a list of cryptocurrency “drop-spots.” In particular, a crypto drop-spot may be used to verify the location of a device by deploying crypto-currency to a certain location, wherein the cryptocurrency can only be collected within certain geographical bounds; if the device collects the crypto-currency, then the device's location is verified. Such data may be utilized in establishing a ZKP, where the predicate response is whether the device collected the cryptocurrency. If the device collected the cryptocurrency, then the device is in an authorized location. If the cryptocurrency is not collected within a certain timeframe, then it is likely the device is not operating within an authorized location.

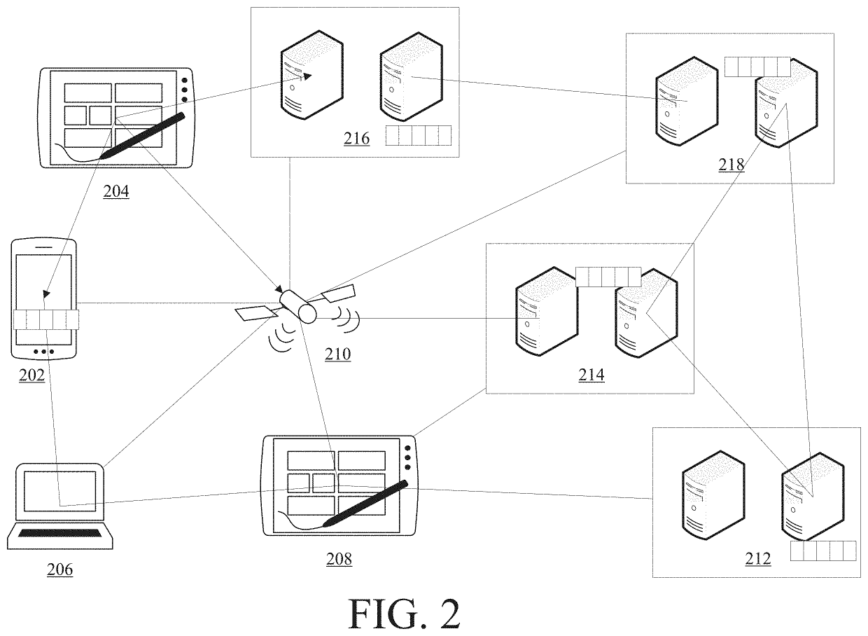

FIG. 2 illustrates an example distributed blockchain architecture for verifying a device geolocation. FIG. 2 is an alternative illustration of a distributed system like FIG. 1. In FIG. 2, each of the network devices are interconnected and communicate with one another. Each device in the network has a copy of the blockchain, as the blockchain is not controlled by any single entity but rather a distributed system, in some examples. In other examples, the blockchain may be a permissioned blockchain that includes an access-control layer, preventing and allowing some devices to read and write certain information to the blockchain.

Specifically, in FIG. 2, mobile device 202, tablets 204 and 208, laptop 206, satellite 210, and server nodes 212-218 are all connected and communicating with one each other in the blockchain network. Each node may store a local copy of the blockchain, or at least a portion of the blockchain. For example, laptop 206 may query the blockchain in the blockchain network, and server 214 may receive the query and produce a block from the copy of the blockchain that is stored on server 214. Laptop 206 may receive the information located within the block (e.g., raw geolocation device data, a ZKP predicate response, etc.). In short, the systems and methods described herein may be implemented within a distributed architecture as displayed in FIG. 2, and in some examples, implemented on a single node within the distributed blockchain network.

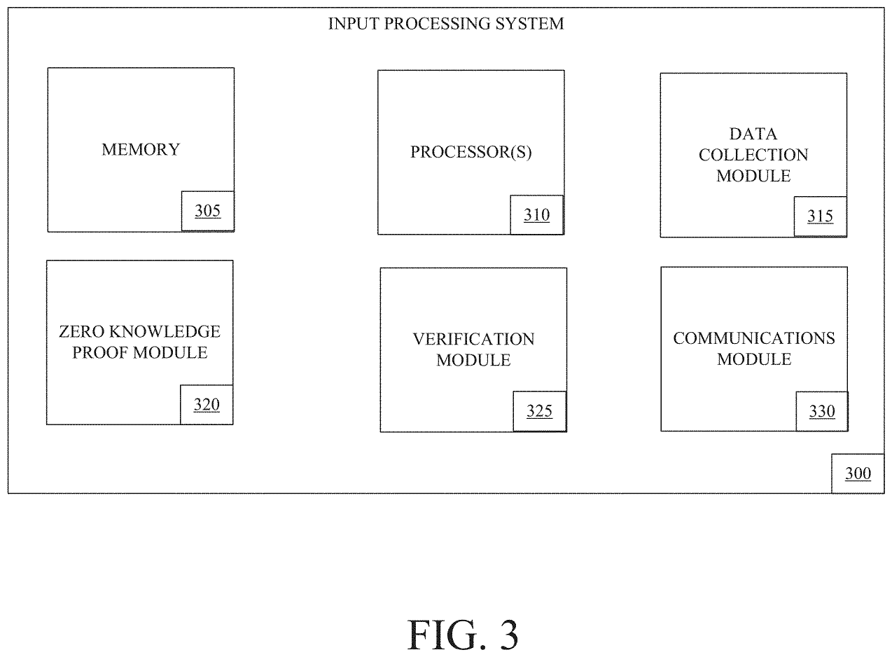

FIG. 3 illustrates an example input processing system for implementing systems and methods for verifying a device geolocation. The input processing system (e.g., one or more data processors) is capable of executing algorithms, software routines, and/or instructions based on processing data provided by a variety of sources related to verifying a device location. The input processing system can be a general-purpose computer or a dedicated, special-purpose computer. According to the embodiments shown in FIG. 3, the disclosed system can include memory 305, one or more processors 310, data collection module 315, zero knowledge proof (ZKP) module 320, verification module 325, and communications module 330. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 305 can store instructions for running one or more applications or modules on processor(s) 310. For example, memory 305 could be used in one or more embodiments to house all or some of the instructions needed to execute the functionality of data collection module 315, ZKP module 320, verification module 325, and communications module 330. Generally, memory 305 can include any device, mechanism, or populated data structure used for storing information, including a local copy of a blockchain data structure. In accordance with some embodiments of the present disclosures, memory 305 can encompass, but is not limited to, any type of volatile memory, nonvolatile memory, and dynamic memory. For example, memory 305 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 305. In some example aspects, memory 305 may store at least one database containing a list of geocoordinates that represent authorized regions and/or a target area. In other examples aspects, memory 305 may store at least one copy of a blockchain used to verify device locations. In yet other example aspects, memory 305 may store raw device geolocations and timestamps that may be submitted to a blockchain or provided to a ZKP construction program (e.g., ZKP module 320) for construction of a ZKP predicate that may then be written to a blockchain. Additionally, memory 305 may store ZKPs that have been applied and may be applied to raw geolocation and timestamp data. Any of the data, programs, and databases that may be stored in memory 305 may be applied to data collected by data collection module 315.

Data collection module 315 may be configured to collect real-time geocoordinate and timestamp data associated with a client device. Data collection module 315 may also be configured to collect data from other nodes in a network, such as “ping” logs describing certain devices that have communicated with those nodes, indicating a certain geographic presence and timestamp (e.g., for corroboration of a device's geolocation data). Data collection module 315 may also receive information from at least one database regarding the geolocation of devices, such as a database indicating authorized regions (e.g., a list of GPS coordinates identifying perimeters of authorized operating regions). In aspects, input processing system 300 may detect, or otherwise be informed of, devices/nodes (e.g., customer devices, user devices, network appliance devices, etc.) that have connected to input processing system 300 or a network thereof. Input processing system 300 may collect and/or store information related to the detected/connected devices and/or the corresponding users. Data collection module 315 may have access to the information collected/stored and may collect or aggregate at least a portion of the collected/stored information. For example, real-time geolocation information associated with a device may be collected and stored by the data collection module 315. Alternately, data collection module 315 may interrogate, or otherwise solicit data from, one or more data sources comprising such information (e.g., other nodes in a network). For example, data collection module 315 may have access to data in one or more external systems, such as content systems, distribution systems, marketing systems, user profiles or preference settings, authentication/authorization systems, device manifests, or the like. Specifically, data collection module 315 may have access to a database of authorized geocoordinates representing an authorized region, which may inform the system whether a device is operating in an authorized region or not, thereby saving time of manually cross-checking raw geocoordinates from a device with authorized region geocoordinates. Data collection module 315 may use a set of APIs or similar interfaces to communicate requests to, and receive response data from, such data sources. In at least one example, the data collection process of data collection module 315 may be triggered according to a preset schedule, in response to a specific user request to collect data (e.g., verifier indicates to system that verifier wants to verify present device location), or in response to the satisfaction of one or more criteria (e.g., a device enters or exits an authorized region). Data collection module 315 may also receive information from devices such as OTA boxes, set-top boxes, smart antennas (e.g., smart OTA antenna), televisions, smart televisions, and the like. Data collection module 315 may be configured to receive GPS coordinates, real-time broadcast signals from local broadcast towers, satellite signals, and GPS coordinate data from end-user devices (e.g., tablets, mobile devices, smart televisions, etc.).

Zero Knowledge Proof (ZKP) module 320 is configured to receive data from data collection module 315 and construct a ZKP based on the received data. For example, ZKP module 320 may receive raw geolocation data associated with a device. Additionally, ZKP module 320 may be configured to receive information from at least one database of authorized regions. In such an example, a ZKP may be constructed where the ZKP predicate response is whether the device geolocation is within an authorized region but does not reveal the actual underlying geocoordinates of the device.

In another example ZKP module 320 may be configured to receive communication logs from other nodes in a network, wherein the logs show a certain device was within a particular geolocation at a certain time (e.g., the device connected/communicated with the node in the network, wherein the connection/communication was recorded in a log). The ZKP module 320 may confirm that the device was in an authorized region based on analysis of these communication logs, specifically identifying a certain log entry showing the device identifier, a geolocation, and a timestamp.

In yet another example, ZKP module 320 may be configured to deploy cryptocurrency to a certain node in a network, where the device in question must obtain the cryptocurrency at the particular geolocation within a certain amount of time to verify the device's location. The ZKP predicate response may be that the device either received or did not receive the cryptocurrency. If the device received the cryptocurrency, then the device is operating in an authorized region.

In a similar example, viewers of a multimedia item (e.g., a movie) may be rewarded for staying until the end of the movie. One way to reward viewers for staying until the end would be to check their device geolocations at a certain time, e.g., specifically when the credits conclude in a movie. However, rather than providing the system the raw geolocation data of a device, users may just want to prove to the system that they watched the credits without revealing the actual underlying geolocation data of their devices. One way to accomplish this is through a ZKP, where the system can airdrop cryptocurrency to a certain geolocation, making it available for collection at a certain time. Once the credits have concluded, the cryptocurrency may be available for collection. A device that is presently in that geolocation at that time may be permitted to collect that cryptocurrency. As such, the underlying system does not receive or know the actual raw geocoordinates of the devices that remained until the end of the credits, but the system does know that the devices were in the geolocation at the end of the credits, implying that the users stayed until the end of the credits and should receive a reward. ZKP module 320 may be configured to deploy cryptocurrency at particular locations to construct ZKPs and ZKP predicate responses.

In another example, ZKP module 320 could be used to construct a ZKP in an insurance claim context. Specifically, in a web-of-trust environment, where the system has trusted devices in a network, the nodes can corroborate certain information associated with a particular geolocation and timestamp. For instance, consider a farmer that submits an insurance claim for flood damage. Normally, a farmer would need to prove to the insurance provider that flood damage indeed occurred by providing the insurance provider with details of the farmland and potentially other personal/confidential business information. Rather than provide these details to the insurance provider, the systems and methods described herein may allow the insurance provider to know whether or not the farmer's land was indeed flooded without having to know the specifics of where the flood happened, what crops were destroyed, what buildings were damaged, etc. In this example, nodes in the geolocation may have recorded certain rainfall data and/or flooding data. If these nodes are in the web-of-trust, then the ZKP that may be constructed is whether the farmland was within the geolocation that was flooded based on the locations and data received from the sensors. If the farmland was within the flooded geolocation, then the ZKP predicate that is produced is that the farmland was flooded based on being within the flooded geolocation. The ZKP predicate and proof may be written to a blockchain via ZKP module 320, so an insurance provider may query the blockchain and verify for itself that the farmland was flooded. In further examples, the insurance contract may be setup as a smart contract, so once the ZKP proof is satisfied (i.e., the farmland is determined to be within the flooded geolocation), the smart contract automatically triggers insurance policy terms, such as depositing a certain amount of money into the farmer's business account for coverage.

Verification module 325 may be configured to receive the ZKP from ZKP module 320, analyze the data collected from data collection module 315, and determine if a device's location is verified. For instance, verification module 325 may receive the ZKP algorithm from 320 and the raw geocoordinates from data collection module 315. If the geocoordinates are indeed within the authorized regions specified in the ZKP algorithm, the device location is verified, and a verification confirmation response may be generated by verification module 325. Alternatively, if the device geolocation is not within the authorized region, then the verification module 325 may determine that the device's location is unverified, and, as such, the verification module 325 may generate a verification unconfirmed message. The response from the verification module 325 may be supplied to communications module 330 for transmission to a verifier, requestor, prover, etc.

Communications module 330 is associated with sending/receiving information (e.g., collected by data collection module 315, ZKP module 320, and verification module 325) with a remote server or with one or more client devices, streaming devices, OTA boxes, set-top boxes, smart televisions, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 330 sends information collected by data collection module 315 and processed by ZKP module 320 and verification module 325. Furthermore, communications module 330 may be configured to communicate a particular ZKP predicate response from ZKP module 320 and a verification message from verification module 325 module to a client device to indicate the verification (or lack thereof) of a device's geolocation. In one example, communications module 330 may be configured to provide a ZKP predicate response in conjunction with a verification statement to a client device, which comprises both the statement of the knowledge and the proof.

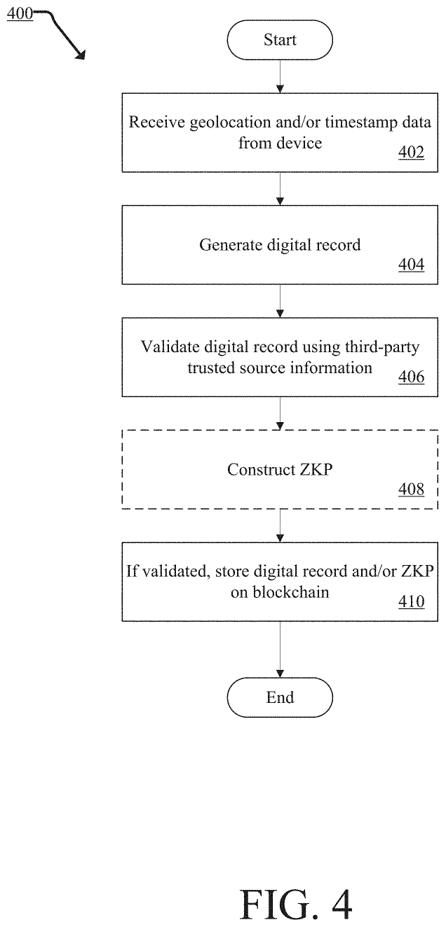

FIG. 4 illustrates an example method for storing a verified device location on a blockchain. Method 400 begins with step 402, receive geolocation and/or timestamp data from the device. This involves the system receiving raw geocoordinates, which may be in the form of discrete GPS coordinates, latitude/longitude, ZIP code, address, etc. The geolocation data may also be in KML format. Additionally, timestamp data may be received, which may be in the form of a Unix timestamp. In some examples, step 402 may involve receiving a log of geolocations and timestamps associated with a device rather than just a single geolocation and timestamp.

Once the geolocation and timestamp are received by the system, the method 400 proceeds to step 404, generate digital record. At step 404, the geolocation data and timestamp data is formatted into a digital record for analysis and/or storage on a blockchain. This may involve converting geolocation data into KML data and/or timestamp data into Unix format. It may also involve converting both geolocation and timestamp data into another unified markup language, such as XML, or a programming language (e.g., Java, JavaScript, Python, C, C++, Solidity, etc.).

Once the digital record is generated, the method 400 proceeds to step 406, where the digital record is validated using third-party trusted source information (e.g., Web of Trust nodes). For example, other nodes in the geolocation that the device provided to the system may be queried for “ping” logs. These logs may contain entries when the device at issue communicated with that particular node, indicating an approximate distance and direction from the node the device at issue communicated with the node, the time the device communicated with the node, and the device identifier. As few as one node may be used to validate the device geolocation or as many as ten or more nodes may be used to validate the device geolocation. In other instances, the validation of the digital record may involve authenticating the raw GPS coordinates that the device initially provided to the system. The GPS coordinate authentication system may be on a server, which may be considered a node within the Web of Trust.

Once the digital record of the device's location is validated, the method 400 may proceed to either store the digital record of the raw geolocation and timestamp data on a blockchain at step 410 or inject a layer of privacy by constructing a ZKP at step 408. Constructing a ZKP at step 408 is an optional step. At step 408, a ZKP is generated based on the digital record of the device's location and third-party information supplied by a database. As noted previously, this third-party information may comprise a database of authorized locations—if the device location digital record is within one of the authorized regions, then the ZKP predicate response may be that the device is indeed operating within an authorized region, without revealing the actual underlying geocoordinates of the device. A ZKP may be constructed using ZKP module 320 from FIG. 3. At step 408, any ZKP may be constructed that does not disclose the raw underlying device data to the verifier yet confirms to the verifier that the device is in a particular area.

Once the digital record is validated and/or the ZKP is constructed (and the ZKP predicate response is created), the digital record and/or ZKP predicate may be stored on a blockchain at step 410, where a verifier may query certain blocks with the relevant information about the device's location. A verifier may be able to use the information written to particular blocks in the blockchain to verify the device's location.

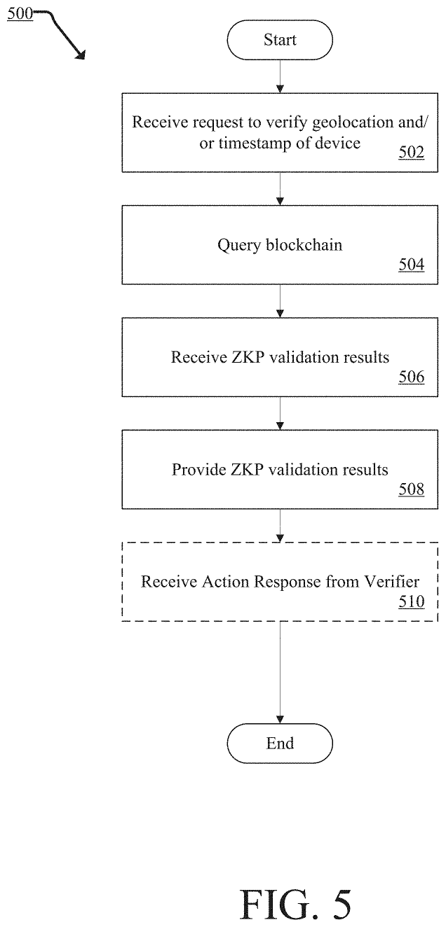

FIG. 5 illustrates an example method for verifying a device location using a zero-knowledge proof. Method 500 begins at step 502, which is receive request to verify geolocation and/or timestamp of a device. This request may be in the form of a read command for a blockchain or a command to obtain a copy of a blockchain in the network.

Once the request is received, the blockchain storing the necessary device location verification information may be queried by the system at step 504. At this point, the system may receive ZKP validation results at step 506, either verifying or not verifying a device's location. The ZKP validation results may comprise a verification response, a ZKP predicate, and/or a proof (i.e., the ZKP algorithm itself). The ZKP validation results will not contain the raw, personally-identifiable data the device originally provided to the system.

Once the ZKP validation results are received by the system at step 506, the ZKP validation results may be provided to the verifier at step 508.

Step 510 is optional, in that the verifier, upon receiving the ZKP validation results may provide an action response back to the system, which the system receives. The action response from the verifier may be, for example, a warning message to be transmitted to a device operating outside of an authorized region. In another example, an action response may be a declination of an offer for sale, if the device's location is not operating in an authorized region (alternatively, the action response may be an acceptance of an offer for sale if the device's location is verified as operating in an authorized region). This may be useful in verifying the integrity of a supply chain. In other examples, the action response may be a disbursement of cryptocurrency to a certain wallet identifier if the device's location is verified.

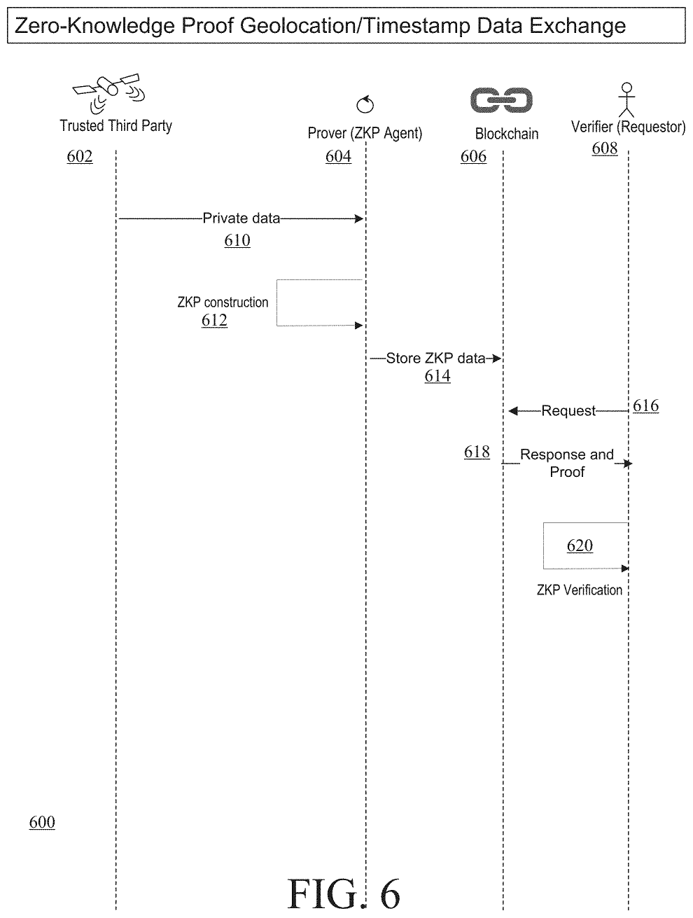

FIG. 6 illustrates an example data exchange using a prover, blockchain, and a verifier. Data exchange environment 600 illustrates four actors: trusted third party, prover, blockchain, and verifier. The trusted third party 602 may be a node in a Web of Trust that the system has already previously verified and uses data from those nodes to corroborate other device location data. A trusted third party 602 may be a GPS satellite, a mobile device, a server, a router, a WiFi node, a computer, video data from a recording device, etc. In other examples, the device in question may serve as the trusted third party, and the system may receive and trust the raw data received from the device without further corroboration. Such raw, private data 610 may be provided to the prover 604, i.e., the ZKP agent. The prover, in some examples, may have the same functionality as ZKP module 320 from the input processing system 300.

At the prover 604, a ZKP may be constructed at 612 based on the private data 610 received from the trusted third party 602. Examples of possible ZKPs that may be constructed to verify a device location are described further with respect to FIG. 3, specifically the ZKP module 320. Once the ZKP is constructed at 612, the ZKP data (proof plus predicate) 614 may be provided (written) to blockchain 606. The ZKP data may be written to the blockchain 606 as another block. Once the ZKP data 614 is on the blockchain 606, a verifier 608 may request such information, e.g., via a read request 616 to the blockchain. Upon receiving the request, the system may transmit the ZKP response and proof 618 to verifier. Upon receiving the response and proof at 618, verifier may proceed to verify the algorithm itself at 620 by applying the response to the algorithm and verifying the proof's accuracy. For instance, the proof may be: if the cryptocurrency has been collected, then the device must have been in X geolocation. If the ZKP predicate is “cryptocurrency successful collected,” then applying the predicate to the proof verifies that the device was within a particular geolocation.

In other examples, blockchain 606 may be a permissioned blockchain that comprises an access control layer. Certain restrictions may be placed on which entities have permission to read and write to the blockchain. For example, the ZKP data transmitted to the blockchain at 614 may also comprise the raw geolocation data of the device in question. However, the raw geolocation data may be stored separately (either through additional security/cryptography or a separate block on the blockchain) that may prevent certain verifiers from accessing that information. In particular, verifiers may have certain read rights to certain blocks but not have read rights to other blocks (e.g., blocks containing the personally-identifiable device geolocation data). In other examples, certain trusted third parties may have the ability to write information to blockchain 606 but others may only have rights to transmit information to the prover 604. Such read/write rights may be determined on a trust indicator of the trusted third party. For example, if a trusted third party device has delivered accurate results ten or more times, rights for that trusted third party to write the data directly to a block in blockchain 606 may be granted, whereas if the results from another third party device have been only 50% accurate, then that third-party device may not have any write rights to the blockchain 606.

FIGS. 7A and 7B illustrate example graphical user interfaces of verifying a geolocation and timestamp of an image displayed on a mobile device. The example implementation 700 illustrated in FIGS. 7A and 7B shows one example use case of the systems and methods described herein. An image 704 is displayed on mobile device 702. The image 704 was originally captured by a separate device at a discrete location at a discrete time. The systems and methods described herein may be applied to the separate device to verify the device's geolocation and timestamp when the image was captured to verify the authenticity of the image 704. The image 702 may be accompanied by image information 706 that describes the media, location, and time. If that location and time are verified according to the blockchain system described herein, then a verification message 708 may appear underneath the image, informing the viewer that the image's geolocation and time that are displayed match up to the records stored on the blockchain. If the image information does not match up (e.g., image information 710 in FIG. 7B) to the records on the blockchain, then a message 712 indicating that the image location and time are not verified may be displayed on mobile device 702.

In further examples, media information 706 and 710 may not be present because the owner/displayer of the image wants to protect certain privacy features of the image. Specifically, the actual location and time the image was captured may be hidden from users. In order to verify that the image is legitimate, then the system may use a ZKP algorithm to verify the location and time of the image without disclosing the actual location and time to the viewer of the image. In such instances, the messages 708 and 712 may still be displayed, indicating whether the geolocation and timestamp data associated with image 704 have been verified.

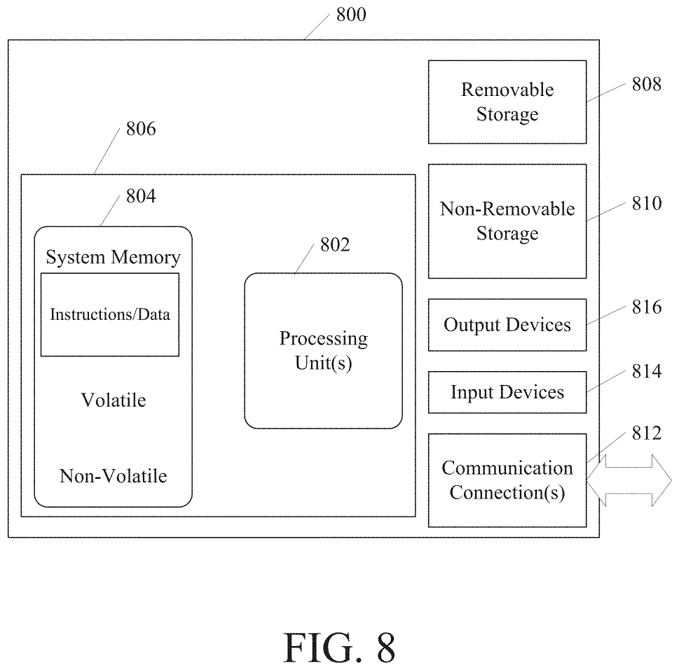

FIG. 8 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 800 typically includes at least one processing unit 802 and memory 804. Depending on the exact configuration and type of computing device, memory 804 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 8 by dashed line 806. Further, environment 800 may also include storage devices (removable 808 and/or non-removable 810) including, but not limited to, magnetic or optical disks or tape. Similarly, environment 800 may also have input device(s) 814 such as keyboard, mouse, pen, voice input, etc., and/or output device(s) 816 such as a display, speakers, printer, etc. Also included in the environment may be one or more communication connections, 812, such as Bluetooth, WiFi, WiMax, LAN, WAN, point to point, etc.

Operating environment 800 typically includes at least some form of computer readable media. Computer readable media can be any available media that can be accessed by processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures (e.g., blockchains), program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 800 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A system comprising:
at least one processor; and
memory coupled to the at least one processor, the memory comprising computer executable instructions that, when executed by the at least one processor, performs a method comprising:
receiving at least one geolocation and at least one timestamp from a device;
generating at least one digital record based on the at least one geolocation and the at least one timestamp;
validating the at least one digital record based on comparing the at least one digital record to data received from at least one trusted third-party device, wherein validating the at least one digital record further comprises verifying the accuracy of the at least one geolocation and the at least one timestamp; and
writing the at least one digital record to at least one blockchain.

2. The system of claim 2, further comprising:
constructing at least one zero-knowledge proof based on the at least one geolocation and the at least one timestamp;
generating at least one zero-knowledge predicate based on the at least one zero-knowledge proof; and
writing the at least one zero-knowledge predicate to the at least one blockchain.

3. The system of claim 2, wherein constructing the at least one zero-knowledge proof further comprises querying at least one database.

4. The system of claim 3, wherein the at least one database is a database of authorized regions.

5. The system of claim 1, wherein comparing the at least one digital record to data received from at least one trusted third-party further comprises analyzing at least one ping log associated with the at least one trusted third-party device.

6. The system of claim 5, wherein the at least one ping log comprises at least one log entry, wherein the at least one log entry comprises a device identifier, a geolocation, and a timestamp.

7. The system of claim 1, wherein the at least one trusted third-party device is at least one of: a mobile device, a computer, a laptop, a tablet, a server, a satellite, a broadcast tower, a cellular tower, a router, a WiFi node, a hotspot, and a video-recording device.

8. The system of claim 1, wherein the at least one geolocation is in KML format.

9. The system of claim 1, wherein the at least one timestamp is a Unix timestamp.

10. The system of claim 4, wherein the at least one zero-knowledge predicate comprises at least one statement that the at least one geolocation is within at least one authorized region from the database of authorized regions.

11. A computer-implemented method for verifying a device location comprising:
receiving at least one geolocation and at least one timestamp from a device;
verifying the at least one geolocation and the at least one timestamp based on comparing the at least one geolocation and the at least one timestamp to at least one ping log received from at least one trusted third-party device;
based on the verification of the at least one geolocation and the at least one timestamp, generating at least one zero-knowledge proof;
generating at least one zero-knowledge predicate based on the at least one zero-knowledge proof; and
writing the at least one zero-knowledge predicate to at least one blockchain.

12. The method of claim 11, further comprising:
receiving a request to verify the device's location from at least one verifier; and
providing the at least one zero-knowledge proof and the at least one zero-knowledge predicate to the at least one verifier.

13. The method of claim 12, further comprising:
receiving at least one action response from the at least one verifier, wherein the at least one action response is at least one of: an acknowledgement message, a warning message to be transmitted to the device, a disbursement of a prize, and a disbursement of money.

14. The method of claim 11, further comprising:
receiving data from at least one database of authorized regions;
based on the data from the at least one database of authorized regions and the at least one geolocation and the at least one timestamp, generating at least one zero-knowledge proof, wherein the at least one zero-knowledge proof verifies whether the at least one geolocation is within at least one authorized region.

15. The method of claim 11, wherein verifying the at least one geolocation and the at least one timestamp further comprises transmitting cryptocurrency to a designated location at a designated timeframe.

16. The method of claim 15, wherein the at least one zero-knowledge proof is satisfied based on at least one indication that the cryptocurrency is collected within the designated timeframe.

17. The method of claim 16, wherein the at least one zero-knowledge predicate comprises a statement whether the device collected the cryptocurrency.

18. The method of claim 11, wherein the at least one trusted third-party device is at least one of: a mobile device, a computer, a laptop, a tablet, a server, a satellite, a broadcast tower, a cellular tower, a router, a WiFi node, a hotspot, and a video-recording device.

19. The method of claim 11, wherein the at least one geolocation is in KML format and the at least one timestamp is a Unix timestamp.

20. A computer-readable media storing computer executable instructions that when executed cause a computing system to perform a method comprising:
receiving at least one geolocation and at least one timestamp from a device;
generating at least one digital record based on the at least one geolocation and the at least one timestamp;
verifying the at least one digital record based on comparing the at least one digital record to data received from at least one trusted third-party device;
querying at least one database of authorized regions;
based on the verification of the at least one digital record and the at least one database of authorized regions, generating at least one zero-knowledge proof, wherein the zero-knowledge proof is satisfied when the at least one digital record shows the at least one geolocation to be within at least one authorized region from the database of authorized regions;
generating at least one zero-knowledge predicate based on the at least one zero-knowledge proof, wherein the zero-knowledge predicate states the device was in at least one authorized region;
writing the at least one zero-knowledge predicate to a block on at least one blockchain;
receiving a request to read the block on the at least one blockchain; and
in response to the read request, providing the at least one zero-knowledge predicate and the at least one zero-knowledge proof.
